(19) United States
(12) Patent Application Publication
(10) Pub. No.: US 2025/0144697 A1
(43) Pub. Date: May 8, 2025

(54) SYSTEM FOR MONITORING VIBRATION RESPONSE OF METAL FLOW IN A PRESS STAMPING PROCESS

(71) Applicants: Ford Global Technologies, LLC, Dearborn, MI (US); CIAB Tech, LLC, Canton, MI (US)

(72) Inventors: James Pelong, Macomb, MI (US); Chandra Sekhar Jalluri, Canton, MI (US)

(73) Assignees: Ford Global Technologies, LLC, Dearborn, MI (US); CIAB Tech, LLC, Canton, MI (US)

(21) Appl. No.: 18/501,845

(22) Filed: Nov. 3, 2023

(51) Int. Cl. B21D 43/02; B21D 22/06; B21D 43/04

(52) U.S. Cl. CPC B21D 43/022; B21D 22/06; B21D 43/04

(57) ABSTRACT

A die for stamping sheet metal comprises a first portion with a convex bead, a second portion with a concave channel, at least one accelerometer positioned near the concave channel. When a sheet metal is positioned between the first portion and the second portion, the first portion and the second portion are configured to be brought together so that the convex bead mates with the concave channel to apply a blank holding force (BHF) to the sheet metal to clamp the sheet metal. The at least one accelerometer measures a time domain parameter or profile or a frequency domain parameter or profile during the placement of the sheet metal.

### FIELD

The present disclosure relates to a system for monitoring operations of a press stamping process.

### BACKGROUND

The statements in this section merely provide background information related to the present disclosure and may not constitute prior art.

Because of the high force loading conditions present in some press stamping operations, various mechanical elements of the press may be prone to premature life span. For example, if it is estimated that a press will have a life span of five years based on certain production levels of stamped parts, and one or more of the press components has a life span of only one or two years, the components will have a premature life span; this may result in significant downtime and lost revenue. Premature life spans of press components may be particularly prevalent when an older press is reconfigured to perform stamping operations subject to forces greater than those considered in the original design parameters.

Furthermore, within the stamping process, when sheet metal is initially formed it is critical to maintain a consistent Blank Holding Force (BHF) for each part formed. The BHF clamps the sheet metal around the edge of the part to be formed between a concave channel in one half of the die and mating convex bead on the other half of the stamping die. During the forming process, the sheet metal is pulled through the clamped point. Variances in the BHF of the clamped sheet metal can occur for several reasons to include but not limited to buildup, wear, press issues, and material properties. These variances can lead to wrinkled, split, and dimensionally incorrect parts. The defective parts are normally not noticed until they have gone through the entire stamping process, which causes excess waste and delayed response to the problem.

The present disclosure addresses challenges related to press stamping processes.

### SUMMARY

This section provides a general summary of the disclosure and is not a comprehensive disclosure of its full scope or all of its features.

In one form of the present disclosure, a die for stamping sheet metal comprises a first portion with a convex bead, a second portion with a concave channel, at least one accelerometer positioned near the concave channel. When a sheet metal is positioned between the first portion and the second portion, the first portion and the second portion are configured to be brought together so that the convex bead mates with the concave channel to apply a blank holding force (BHF) to the sheet metal to clamp the sheet metal. The at least one accelerometer measures a time domain parameter or profile or a frequency domain parameter or profile during the placement of the sheet metal.

In variations of this die, which may be implemented individually or in any combination: the first portion comprises a pre-formed convex shape, and the second portion comprises a pre-formed concave shape; when the first portion and the second portion are brought together to clamp the sheet metal, a part is produced with a shape defined by the pre-formed concave shape and the pre-formed convex shape; the at least one accelerometer comprises a plurality of accelerometers positioned about the periphery of the concave channel; if the time domain parameter or profile or the frequency domain parameter or profile exceed an upper limit, the BHF is excessive; if the time domain parameter or profile or the frequency domain parameter or profile are below a lower limit, the BHF is not sufficient; the die further comprises a bolster, the second portion being secured to the bolster; the die further comprises at least another accelerometer positioned on the bolster to measure a time domain parameter or profile or a frequency domain parameter or profile during the placement of the sheet metal between the first portion and the second portion; and the at least another accelerometer comprises a second plurality of accelerometers.

In another form, a die for stamping sheet metal comprises a first portion with a convex bead, a second portion with a concave channel, a bolster, the second portion being secured to the bolster, and at least one accelerometer positioned on the bolster. When a sheet metal is positioned between the first portion and the second portion, the first portion and the second portion are configured to be brought together so that the convex bead mates with the concave channel to apply a blank holding force (BHF) to the sheet metal to clamp the sheet metal. The at least one accelerometer measures a time domain parameter or profile or a frequency domain parameter or profile during the placement of the sheet metal.

In variations of this die, which may be implemented individually or in any combination: the die further comprises at least another accelerometer positioned near the concave channel to measure a time domain parameter or profile or a frequency domain parameter or profile during the placement of the sheet metal between the first portion and the second portion; the first portion comprises a pre-formed convex shape, and the second portion comprises a pre-formed concave shape; when the first portion and the second portion are brought together to clamp the sheet metal, a part is produced with a shape defined by the pre-formed concave shape and the pre-formed convex shape; wherein the at least one accelerometer comprises a plurality of accelerometers positioned on the bolster; if the time domain parameter or profile or the frequency domain parameter or profile exceed an upper limit, the BHF is excessive; and if the time domain parameter or profile and the frequency domain parameter or profile are below a lower limit, the BHF is not sufficient.

In yet another form, a system for stamping sheet metal comprises a first portion with a convex bead, a second portion with a concave channel, a bolster, the second portion being secured to the bolster, a plurality of accelerometers positioned at least on the second portion and the bolster, a processing unit that communicates with the plurality of accelerometers. when a sheet metal is positioned between the first portion and the second portion, the first portion and the second portion are configured to be brought together so that the convex bead mates with the concave channel to apply a blank holding force (BHF) to the sheet metal to clamp the sheet metal. The the plurality of accelerometers measures a time domain parameter or profile or a frequency domain parameter or profile during the placement of the sheet metal that is communicated to the processing unit.

In variations of this system, which may be implemented individually or in any combination: the first portion comprises a pre-formed convex shape, and the second portion comprises a pre-formed concave shape, and wherein when the first portion and the second portion are brought together to clamp the sheet metal, a part is produced with a shape defined by the pre-formed concave shape and the pre-formed convex shape; if the time domain parameter or profile or the frequency domain parameter or profile exceed an upper limit, the BHF is excessive; and if the time domain parameter or profile or the frequency domain parameter or profile are below a lower limit, the BHF is not sufficient.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a press for stamp pressing in accordance with the principles of the present disclosure;

FIG. 2 shows a lower portion of the press in accordance with the principles of the present disclosure;

FIG. 3 shows various stages of a stamping process in accordance with the principles of the present disclosure;

FIGS. 4A and 4B show a comparison in the time domain parameter or profile between a stamping process with shims and with some shims removed in accordance with the principles of the present disclosure; and

FIG. 5 shows a comparison in the time domain parameter or profile of an accelerometer on the bolster for two different cycles in accordance with the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

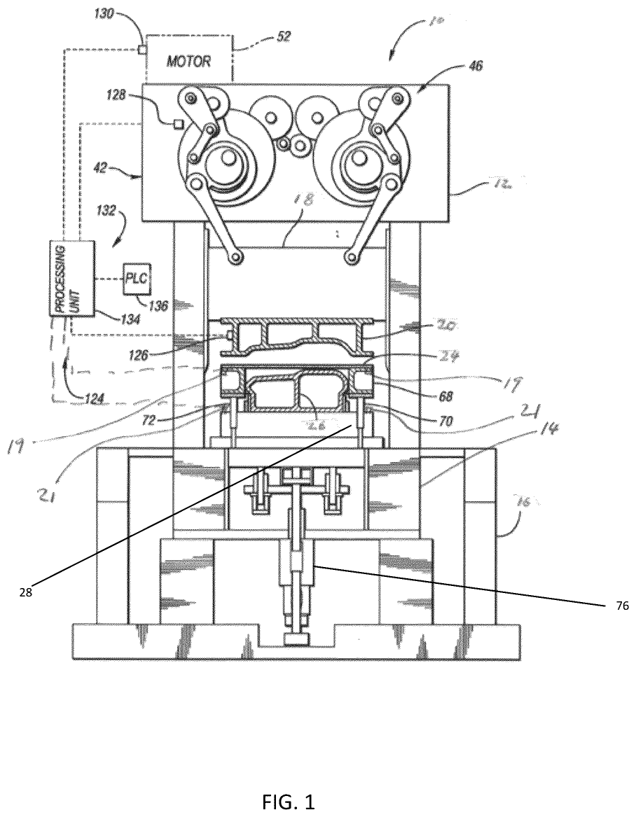

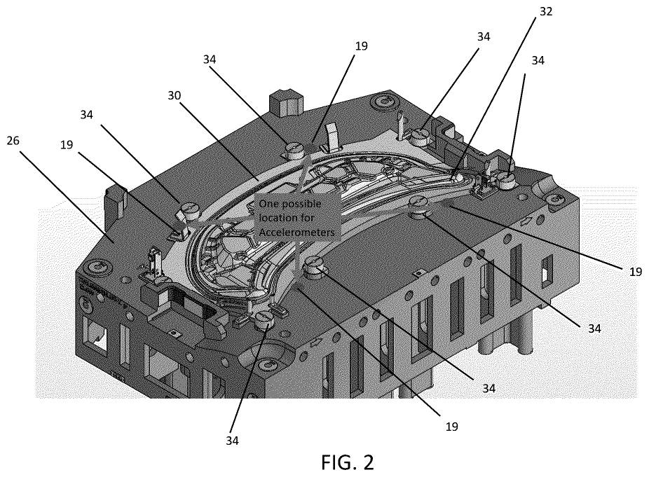

Referring to FIGS. 1 and 2, a single action press 10 utilized for stamping a metal part is illustrated. The press 10 includes a crown 12 and a press bed 14 supported on a foundation 16. The press 10 includes a slide 18 that moves downward in carrying with it an upper portion 20. The upper portion 20 captures a workpiece 24, such as, for example, sheet metal, between it and a lower portion 26 positioned on a bolster 28.

As shown in FIG. 1, the lower portion 26 is firmly attached to the press bed 14 so there is little force imparted when the upper portion 20 engages the workpiece 24. After the workpiece 24 is securely clamped between the upper and lower portions 20, 26, the slide 18 is actuated and moved downward, carrying with it a portion of a die. The upper portion contacts the workpiece 24, drawing it into another portion of the die on the lower portion 26. The force imparted of this action is not very high, since the movement is just the upper portion 20 drawing the already fixed workpiece 24 into the lower portion 26. Attached to the crown 12 is a toggle drive system 46 made up of flywheels, gears, and other elements identified as 42. A motor 52 is utilized to provide mechanical power to the toggle drive system 46. Accordingly, the upper portion 20 and the lower portion 26 form a press assembly with a single slide 18. The lower portion includes a mold 30 and a set of stop blocks 34 positioned about the mold 30. The mold 30 includes a concave channel 32, and the upper portion 20 includes a corresponding mold with a convex bead. As such, the mold 30, the concave bead, and the stop blocks 34 mate with corresponding elements of the upper portion 20.

The upper portion 20 is configured to mate with the lower portion 26 to form the workpiece 24 into a desired shape. The press 10 further includes a blank holder 68 that is supported by nitrogen springs 70, 72. In addition, the press 10 includes a hydraulic draw cushion assembly 74 supported by the press foundation 76, which helps to absorb some of the forces during operation of the press 10. When the press 10 is operated, the elements of the press 10 may each have an actual life span that generally coincides with its expected life span. As a single action press the press 10 facilitates faster transfers and additional operations on the workpiece 24.

In operation, FIG. 1 shows the press 10 with the drawing slide 18 in a raised position, with the unformed workpiece 24. The nitrogen springs 70, 72 raise the blank holder 68 above the top of the lower portion 26, such that the unformed workpiece 24 is supported by the blank holder 68, which provides a convenient orientation for the finished workpiece. The velocity of the lower portion 26 moves from zero velocity to match the velocity of the upper portion 20 as the slide 18 moves downward to apply a force to the workpiece 24, capture it between the upper portion 20 and the blank holder 68, and then, the workpiece 24, and the blank holder 68, is moved from zero velocity to match the velocity of the upper portion 20 as all three components move downward on the nitrogen cylinders 70, 72. When the workpiece is positioned between the lower portion 26 and the upper portion 20, the lower portion 26 and the upper portion 20 are configured to be brought together so that the convex bead mates with the concave channel 32 to apply a blank holding force (BHF) to the workpiece 24 to clamp the workpiece 24. To provide vibration data that can be utilized, for example, to alter operation of the press 10, one or more vibration sensors, which may be in the form of accelerometers 19 positioned on the lower portion 26 and one or more accelerometers 21 positioned on the bolster 28.

A system for monitoring the operation of the press 10 is shown generally at 124 in FIG. 1. The system 124 includes vibration sensors 126, 128, 130, each of which is in communication with a control system 132. The control system 132 includes a processing unit 134 having an electronic controller and memory therein, and a PLC 136 connected to the processing unit 134. A baseline vibration level defining a boundary for vibrations beyond which one or more of the elements of the press 10 have a reduced life expectancy can be determined empirically through observation of the press operation correlated with information measured by a sensor. Such as the sensor 126 on the upper portion 20.

The baseline vibration level can be established using a system, such as the system 124, or it can be independently established. The baseline vibration level information can be stored in the processing unit 134, for example, in the form of a lookup table. The PLC 136 provides additional information to the processing unit 134 related to specific operation of the press 10. Such as the position of the elements of the drive system 46 and the position of the drawing slide 18. The processing unit 134 also receives vibration data from the sensors 128, 130, and can correlate this information with information measured from the sensor 126 on the upper portion 20.

The processing unit 134 can use one or more preprogrammed algorithms to establish a relationship between the vibration data measured by the sensor 126 and the other vibration data input from the other sensors, such as the sensors 128, 130. Even after the sensor 126 is removed from the upper portion 20, the processing unit 134 can continue to receive information from the sensors 128, 130, and compare this information to the previously determined baseline vibration level. If at any time, vibrations measured by the sensors 128, 130 exceed the baseline vibration level, the processing unit 134 can send an appropriate fault signal to alert an operator or production manager that an adjustment needs to be made. For example, it may be desirable to adjust some of the operation parameters of the press to help ensure that the vibration levels remain below the baseline vibration level, or it may be determined that keeping these vibration levels above the baseline vibration level is acceptable, understanding that certain press elements may need to be replaced before they have reached their expected life span.

To capture peak vibrations, it is desirable to have a very high data acquisition rate to retrieve the vibration information from the sensors 126, 128, 130. For example, the raw signals from the sensors 126, 128, 130 can be sampled at a rate greater than 50,000 samples per second, thereby enabling capture of signals with maximum frequency of up to 10 kilohertz (KHz). One way to establish the baseline vibration level is to measure the vibrations over a long period of time during many different operations, collecting the vibration history, and correlating this with mechanical features of the press elements. In this way, a relationship between vibrations at the press 10 and the reduced life-span of the press components can be determined.

The accelerometers 19 and 21 also communicate with the processing unit 134. The accelerometers 19 and 21 measure a time domain parameter or profile or a frequency domain parameter or profile of the workpiece 24 flow through the clamped points and identify deviations from an ideal profile for each specific part being formed. As described above, there are multiple locations within the stamping die and press which are utilized for accelerometer mounting to include but not limited to on the mold or die close to the metal forming, on the shoe (outer casing) of the lower portion 26, and on the bolster 28 that the lower portion 26 is mounted to. The time domain parameter or profile or the frequency domain parameter or profile may be a function of the speed and or other process parameters at which the stamping press is ran and baselines are established through the stamping press parameters. Furthermore, the time domain parameter or profile or the frequency domain parameter or profile can be inputs into an artificial intelligence model which can be trained to identify the specific issues which cause specific changes in the inputs and notify the operations team in advance of producing defects.

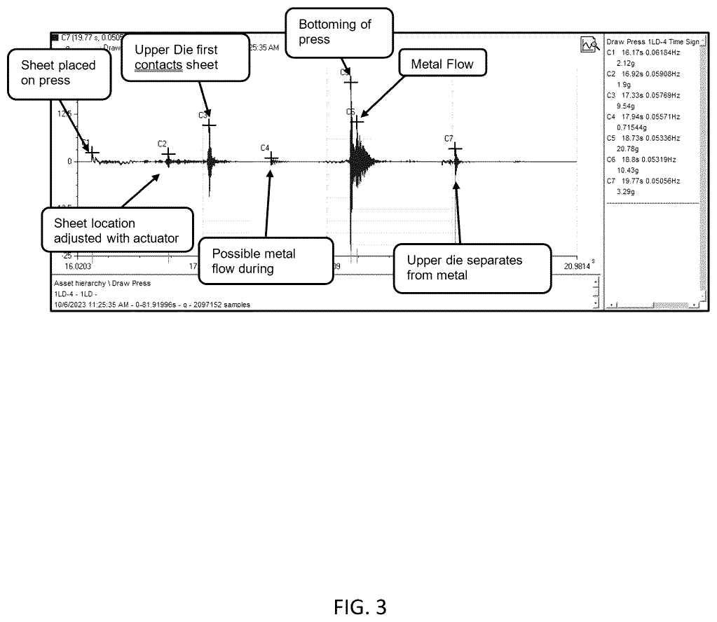

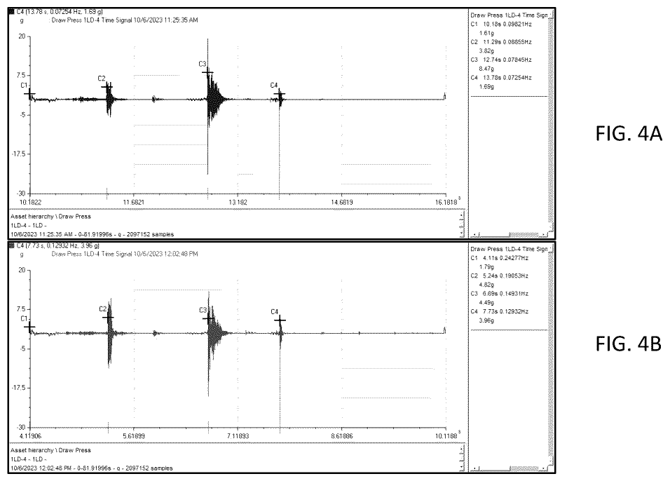

Turning to FIG. 3, various stages of a stamping process are illustrated as measured with an accelerometer 19. Specifically, FIG. 3 illustrates the amplitude of vibrations versus time measured with one or more accelerometers. In the first stage, a workpiece 24, such as a sheet metal, is placed in the press 10. Next, the location of the workpiece 24 is adjusted with an actuator. In the third stage, the upper portion or die 20 contacts the workpiece 24. In the fourth stage, the accelerometer measures possible metal flow. In the fifth stage, the accelerometer 19 indicates the bottoming of the press 10, and in the sixth stage, the accelerometer 19 identifies metal flow. Finally, in the seventh stage the accelerometer identifies when the upper portion or die 20 separates from the workpiece 24. Hence, the accelerometer 19 is able to identify metal flow and when the upper and lower portions 20, 26 come together and separate. If the time domain parameter or profile or the frequency domain parameter or profile measured by the accelerometer exceed an upper limit the BHF is too tight, and if the time domain parameter or profile or the frequency domain parameter or profile are below a lower limit, the BHF is too loose. For example, as shown in FIGS. 4A and 4B, the use of the accelerometers 19 and/or 21 identify the proper number of shims to be placed under the stop blocks 34. Specifically, FIG. 4A indicates the proper number of shims, while FIG. 4B indicates an insufficient number of shims.

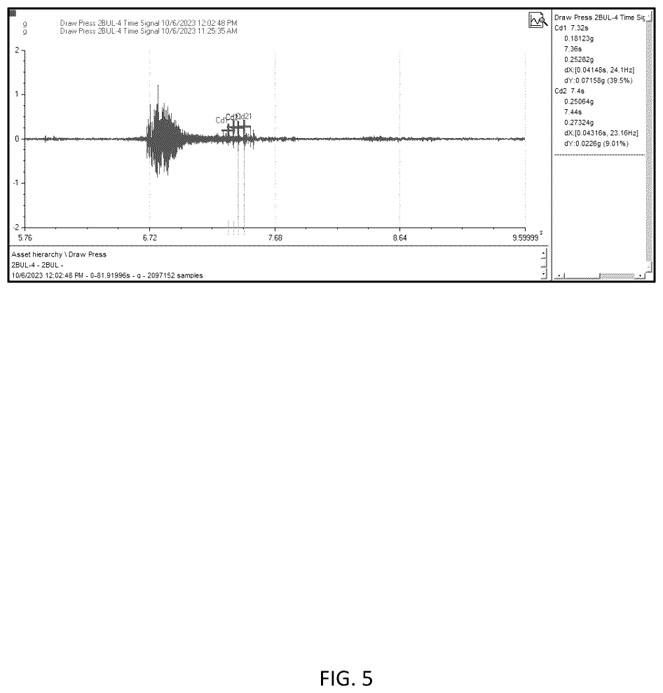

Referring now to FIG. 5, there is shown vibration signatures as measured with one or more of the accelerometers 21 positioned on the bolster 28 for two different press cycles. The lighter signature shifted to the left indicates a misalignment of the upper and lower portions 20, 26, while the darker signature shifted to the right indicates proper alignment of the upper and lower portions 20, 26. In various arrangements of the press 10, when the vibration signature of the accelerometers 19 match with that of the accelerometers 21, subsequent lower portions 26 are not provided with accelerometers, since the accelerometers 21 on the bolster 28 provide sufficient feedback to the operation of the press 10.

Among other benefits and advantages, the press 10 identifies process variances predictively, heightens quality control, and reduces waste. Further, the press 10 reduces the number of people to sort quality issues and reduces downtown to investigate issues.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A die for stamping sheet metal, the die comprising:
a first portion with a convex bead;
a second portion with a concave channel; and
at least one accelerometer positioned near the concave channel,
wherein when a sheet metal is positioned between the first portion and the second portion, the first portion and the second portion are configured to be brought together so that the convex bead mates with the concave channel to apply a blank holding force (BHF) to the sheet metal to clamp the sheet metal, and wherein the at least one accelerometer measures a time domain parameter or profile or a frequency domain parameter or profile during placement of the sheet metal.

2. The die of claim 1, wherein the first portion comprises a pre-formed convex shape, and the second portion comprises a pre-formed concave shape.

3. The die of claim 2, wherein when the first portion and the second portion are brought together to clamp the sheet metal, a part is produced with a shape defined by the pre-formed concave shape and the pre-formed convex shape.

4. The die of claim 1, wherein the at least one accelerometer comprises a plurality of accelerometers positioned about a periphery of the concave channel.

5. The die of claim 1, wherein if the time domain parameter or profile or the frequency domain parameter or profile exceed an upper limit, the BHF is excessive.

6. The die of claim 1, wherein if the time domain parameter or profile or the frequency domain parameter or profile are below a lower limit, the BHF is not sufficient.

7. The die of claim 1, further comprising a bolster, the second portion being secured to the bolster.

8. The die of claim 7, further comprising at least another accelerometer positioned on the bolster to measure a time domain parameter or profile or a frequency domain parameter or profile during placement of the sheet metal between the first portion and the second portion.

9. The die of claim 8, wherein the at least another accelerometer comprises a second plurality of accelerometers.

10. A die for stamping sheet metal, the die comprising:
a first portion with a convex bead;
a second portion with a concave channel;
a bolster, the second portion being secured to the bolster; and
at least one accelerometer positioned on the bolster,
wherein when a sheet metal is positioned between the first portion and the second portion, the first portion and the second portion are configured to be brought together so that the convex bead mates with the concave channel to apply a blank holding force (BHF) to the sheet metal to clamp the sheet metal, and wherein the at least one accelerometer measures a time domain parameter or profile or a frequency domain parameter or profile during placement of the sheet metal.

11. The die of claim 10, further comprising at least another accelerometer positioned near the concave channel to measure a time domain parameter or profile or a frequency domain parameter or profile during placement of the sheet metal between the first portion and the second portion.

12. The die of claim 10, wherein the first portion comprises a pre-formed convex shape, and the second portion comprises a pre-formed concave shape.

13. The die of claim 12, wherein when the first portion and the second portion are brought together to clamp the sheet metal, a part is produced with a shape defined by the pre-formed concave shape and the pre-formed convex shape.

14. The die of claim 10, wherein the at least one accelerometer comprises a plurality of accelerometers positioned on the bolster.

15. The die of claim 10, wherein if the time domain parameter or profile or the frequency domain parameter or profile exceed an upper limit, the BHF is excessive.

16. The die of claim 10, wherein if the time domain parameter or profile or the frequency domain parameter or profile are below a lower limit, the BHF is not sufficient.

17. A system for stamping sheet metal, the system comprising:
a first portion with a convex bead;
a second portion with a concave channel;
a bolster, the second portion being secured to the bolster;
a plurality of accelerometers positioned at least on the second portion and the bolster; and
a processing unit that communicates with the plurality of accelerometers,
wherein when a sheet metal is positioned between the first portion and the second portion, the first portion and the second portion are configured to be brought together so that the convex bead mates with the concave channel to apply a blank holding force (BHF) to the sheet metal to clamp the sheet metal, and wherein the plurality of accelerometers measures a time domain parameter or profile or a frequency domain parameter or profile during placement of the sheet metal that is communicated to the processing unit.

18. The system of claim 17, wherein the first portion comprises a pre-formed convex shape, and the second portion comprises a pre-formed concave shape, and wherein when the first portion and the second portion are brought together to clamp the sheet metal, a part is produced with a shape defined by the pre-formed concave shape and the pre-formed convex shape.

19. The system of claim 17, wherein if the time domain parameter or profile or the frequency domain parameter or profile exceed an upper limit, the BHF is excessive.

20. The system of claim 17, wherein if the time domain parameter or profile or the frequency domain parameter or profile are below a lower limit, the BHF is not sufficient.
